(19) United States
(12) Patent Application Publication
(10) Pub. No.: US 2026/0039119 A1
(43) Pub. Date: Feb. 5, 2026

(54) PHOTOVOLTAIC POWER DISAGGREGATION FROM METERED NET LOAD

(71) Applicant: Utilidata, Inc., Providence, RI (US)

(72) Inventors: Kevin Smith, Portland, OR (US); Ashley King, East Greenwich, RI (US); Daria Pankova, State College, PA (US)

(73) Assignee: Utilidata, Inc., Providence, RI (US)

(21) Appl. No.: 18/982,142

(22) Filed: Dec. 16, 2024

Related U.S. Application Data
(60) Provisional application No. 63/679,351, filed on Aug. 5, 2024.

(51) Int. Cl. H02J 3/38; B60L 53/51; B60L 53/53; B60L 53/62; H02J 3/28

(52) U.S. Cl. CPC H02J 3/381; B60L 53/51; B60L 53/53; B60L 53/62; H02J 3/28; H02J 2203/20; H02J 2300/24

(57) ABSTRACT

Systems and methods for solar voltaic disaggregation from metered net load is presented. A processor coupled with memory can be configured to identify, using a model trained for a site electrically coupled with an electricity distribution grid, a tilt, azimuth, and capacity factor for a photovoltaic system at the site. The processor can receive, from a data repository, irradiance data for a first time interval. The processor can determine an amount of power generated by the photovoltaic system during the first time interval based on the irradiance data, the tilt, the azimuth, and the capacity factor. The processor can execute an action related to power delivery to the site based on the amount of power generated by the photovoltaic system during the first time interval.

### CROSS-REFERENCES TO RELATED APPLICATIONS

This application claims the benefit of priority under 35 U.S.C. § 119 to U.S. Provisional Application No. 63/679,351, filed Aug. 5, 2024, which is hereby incorporated by reference here in in its entirety.

### FIELD OF THE DISCLOSURE

This disclosure relates generally to systems and methods for solar voltaic disaggregation from metered net load.

### BACKGROUND

Utility distribution grids can generate and distribute electric power to various customer sites. The utility distribution grids can supply power via transmission or distribution lines to various loads at the customer sites, such as consumer electric devices or residential charging infrastructures.

### BRIEF SUMMARY OF THE DISCLOSURE

The utility distribution grids can use meters to observe or measure utility delivery or consumption in the grid. These meters, among other components within utility distribution grids, can collect samples of power delivery or consumption, such as voltage information, at a sample rate (e.g., one sample every 15 to 60 minutes). The utility distribution grids (e.g., electrical distribution systems) can include distributed energy resources (DERs), such as photovoltaics (PV), energy storage systems (ESS), electric vehicles (EVs), and other electric generators or electric storage. These DERs can assist with the distribution of electricity, thereby allowing a decentralized, bidirectional smart grid. In some aspects, as the number of PVs (e.g., solar panels) for residential areas or homes increases, it may be desired to accurately determine the power generated from the PVs to maintain grid stability during changes in electrical load or changes to the generated power from the PVs due to varying environmental factors, e.g., cloud movement, daylight time, humidity, etc. For example, the utility grid can plan for the fast-acting, reserve-power resources according to the amount of masked load on the circuits. Hence, by determining the power generation from the PVs, the utilities can test the effects of different inverter functions to improve circuit conditions, for instance, allowing for voltage or reactive power (volt-var) control to support voltage or real-power curtailment to reduce reverse power flow.

The technical solutions discussed herein can provide features and operations for determining or estimating the PV power from meter net load measurements. The systems and methods can account for the effects of at least shading, temperature, or other environmental factors on the output of the PV, improving the accuracy of estimating the power generated from as-installed solar panel parameters without relying on submetered measurements from the PV. The technical solutions can be directed to systems and methods for solar voltaic disaggregation from metered net load. A system can include a data processing system comprising one or more processors, coupled with memory, to determine photovoltaic (PV) parameters associated with an entity based on at least historical net load data, historical irradiance data, and historical solar angle data associated with the entity. The data processing system can determine, using the model, disaggregated PV time series of the entity based on at least the PV parameters.

An aspect of the technical solutions is directed to a system. The system can include one or more processors, coupled with memory. The one or more processors can be configured via instructions or data stored in the memory to cause the one or more processors to implement or execute various actions or functionalities. The one or more processors can be configured to identify, using a model trained for a site electrically coupled with an electricity distribution grid, a tilt, azimuth, and capacity factor for a photovoltaic system at the site. The one or more processors can be configured to receive, from a data repository, irradiance data for a first time interval. The one or more processors can be configured to determine an amount of power generated by the photovoltaic system during the first time interval based on the irradiance data, the tilt, the azimuth, and the capacity factor. The one or more processors can be configured to execute an action related to power delivery to the site based on the amount of power generated by the photovoltaic system during the first time interval.

The one or more processors can be configured to determine an in-plane irradiance based on the irradiance data, the tilt and the azimuth. The one or more processors can be configured to determine the amount of power generated by the photovoltaic system based on the in-plane irradiance and the capacity factor. The one or more processors can be configured to identify geographic coordinates for the site and transmit, using an application programming interface, via a network, a request for the irradiance data. The request can include the geographic coordinates for the site and an indication of the first time interval. The one or more processors can be configured to receive the irradiance data responsive to the request. The irradiance data can include a direct normal irradiance, a diffuse horizontal irradiance, and a global horizontal irradiance.

The one or more processors can be configured to train the model for the site based on geographic coordinates for the site, an elevation of the site, and timeseries data comprising historical base-adjusted net-load data for the site, historical irradiance data for the site, and solar position data. The one or more processors can be configured to identify historical net-load time series data for the site. The one or more processors can be configured to determine a base load for the site, wherein the base load corresponds to a minimum load present at each time stamp in the historical net-load time series data. The one or more processors can be configured to generate the historical base-adjusted net-load data based on a difference between a net-load for the site and the base load time series data for the site.

The one or more processors can be configured to generate historical in-plane irradiance time series data for the site based on the historical irradiance data and the solar position data. The one or more processors can be configured to generate minimum capacity factor time series data based on the historical base-adjusted net-load data and the historical in-plane irradiance time series data. The one or more processors can be configured to determine the capacity factor for the photovoltaic system at the site based on a percentile range of the minimum capacity factor time series data.

The one or more processors can be configured to select the tilt and the azimuth for the capacity factor that corresponds to a minimum value of the minimum capacity factor time series data within the percentile range. The one or more processors can be configured to compare the amount of power generated by the photovoltaic system during the first time interval with a threshold. The one or more processors can be configured to determine, based on the comparison, to adjust a voltage tap setting on the electricity distribution grid. The one or more processors can be configured to execute the action to adjust the voltage tap setting responsive to the determination.

The one or more processors can be configured to compare the amount of power generated by the photovoltaic system during the first time interval with a threshold. The one or more processors can be configured to determine, based on the comparison, to activate one or more capacitors on the electricity distribution grid. The one or more processors can be configured to execute the action to activate the one or more capacitors on the electricity distribution grid.

The one or more processors can be configured to determine, based on the amount of power generated by the photovoltaic system during the first time interval, to adjust power delivery by an electric vehicle charger at the site. The one or more processors can be configured to execute the action to adjust the power delivery by the electric vehicle charger at the site responsive to the determination. The one or more processors can be configured to determine, based on the amount of power generated by the photovoltaic system during the first time interval, to adjust power delivery by a battery energy storage system at the site. The one or more processors can be configured to execute the action to adjust the power delivery by the battery energy storage system at the site responsive to the determination. The one or more processors can be located on a data processing system remote from the site. The one or more processors can be located on a device at the site.

An aspect of the technical solutions is directed to a method. The method can include one or more actions implemented via one or more processors that are configured to implement the actions using instructions or data stored in memory coupled with the one or more processors. The method can include one or more processors that are coupled with memory identifying, using a model trained for a site electrically coupled with an electricity distribution grid, a tilt, azimuth, and capacity factor for a photovoltaic system at the site. The method can include the one or more processors receiving, from a data repository, irradiance data for a first time interval. The method can include the one or more processors determining an amount of power generated by the photovoltaic system during the first time interval based on the irradiance data, the tilt, the azimuth, and the capacity factor. The method can include the one or more processors executing an action related to power delivery to the site based on the amount of power generated by the photovoltaic system during the first time interval.

The method can include determining, by the one or more processors, an in-plane irradiance based on the irradiance data, the tilt and the azimuth. The method can include determining, by the one or more processors, the amount of power generated by the photovoltaic system based on the in-plane irradiance and the capacity factor. The method can include identifying, by the one or more processors, geographic coordinates for the site. The method can include transmitting, by the one or more processors, using an application programming interface, via a network, a request for the irradiance data. The request can include the geographic coordinates for the site and an indication of the first time interval. The method can include receiving, by the one or more processors, the irradiance data responsive to the request.

The method can include training the model for the site based on geographic coordinates for the site, an elevation of the site, and timeseries data comprising historical base-adjusted net-load data for the site, historical irradiance data for the site, and solar position data. The method can include comparing, by the one or more processors, the amount of power generated by the photovoltaic system during the first time interval with a threshold. The method can include determining, by the one or more processors, based on the comparison, to adjust a voltage tap setting on the electricity distribution grid. The method can include executing, by the one or more processors, the action to adjust the voltage tap setting responsive to the determination.

An aspect of the technical solutions is directed to a non-transitory computer-readable medium storing processor-executable instructions. The instructions, when executed by one or more processors, can cause the one or more processors that are coupled with memory, to identify, using a model trained for a site electrically coupled with an electricity distribution grid, a tilt, azimuth, and capacity factor for a photovoltaic system at the site. The instructions, when executed by one or more processors, can cause the one or more processors to receive, from a data repository, irradiance data for a first time interval. The instructions, when executed by one or more processors, can cause the one or more processors to determine an amount of power generated by the photovoltaic system during the first time interval based on the irradiance data, the tilt, the azimuth, and the capacity factor. The instructions, when executed by one or more processors, can cause the one or more processors to execute an action related to power delivery to the site based on the amount of power generated by the photovoltaic system during the first time interval.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification.

### BRIEF DESCRIPTION OF THE FIGURES

The accompanying drawings are not intended to be drawn to scale. Like reference numbers and designations in the various drawings indicate like elements having similar structure or functionality. For purposes of clarity, not every component may be labeled in every drawing. In the drawings:

FIG. 1 is a block diagram depicting an illustrative utility grid, in accordance with an implementation;

FIG. 2 illustrates a block diagram of a data processing system for photovoltaic power disaggregation from metered net-load;

FIG. 3 is a block diagram illustrating an architecture for a computer system that can be employed to implement elements of the systems and methods described and illustrated herein, including, for example, aspects of the utility grid depicted in FIG. 1;

FIG. 4 depicts an example graph of irradiance and negated based-adjusted net load and an example graph of the minimum capacity factor computed from the irradiance and the negated based-adjusted net load, in accordance with an implementation; and

FIG. 5 illustrates a flow diagram of a method for providing photovoltaic power disaggregation from the metered net-load, in accordance with some examples.

The features and advantages of the present solution will become more apparent from the detailed description set forth below when taken in conjunction with the drawings, in which like reference characters identify corresponding elements throughout. Other features, aspects, and advantages of the subject matter will become apparent from the description, the drawings, and the claims.

### DETAILED DESCRIPTION

Following below are more detailed descriptions of various concepts related to, and implementations of, methods, apparatuses, and systems of solar voltaic disaggregation from metered net load. The various concepts introduced above and discussed in greater detail below may be implemented in any of numerous ways.

The systems and methods of the technical solution can include a utility distribution grid, e.g., including a smart grid distributed operations platform (SGDOP), to provide the capabilities of the grid edge intelligence (e.g., metering devices) for disaggregating the PV (e.g., solar voltaic, solar panel, or solar array) from the metered net load. The PV can be a part of the DERs of the utility distribution grids, assisting the utility distribution grids with managing the distribution of electricity. With the increasing installations or usage of PVs in various residential areas, accurate determination of power generated by the PVs which accounts for at least the varying environmental factors (e.g., cloud movements, shading, temperature, or weather) may be desired to maintain grid stability during changes to the electrical load and generated power from the PVs. For example, the utility grid can plan for the fast-acting, reserve-power resources according to the amount of masked load on the circuits, e.g., the load being served by the residential solar power to the utility. By accurately determining the power generation from the PVs, the utility grid can test the effects of different inverter functions to improve circuit conditions, for instance, allowing for voltage or reactive power (volt-var) control to support voltage or real-power curtailment to reduce reverse power flow.

The systems and methods of the technical solution discussed herein can provide features and operations for determining or estimating the PV power generation (e.g., solar power generation) from meter net load measurements. The systems and methods can account for the effects of at least shading, temperature, or other environmental factors on the output of the PV to improve the accuracy of estimating the power generated from as-installed solar panel parameters (e.g., sometimes referred to as panel parameters, solar array parameters, or PV parameters) without requiring submetered measurements from the PV (e.g., solar array or panel).

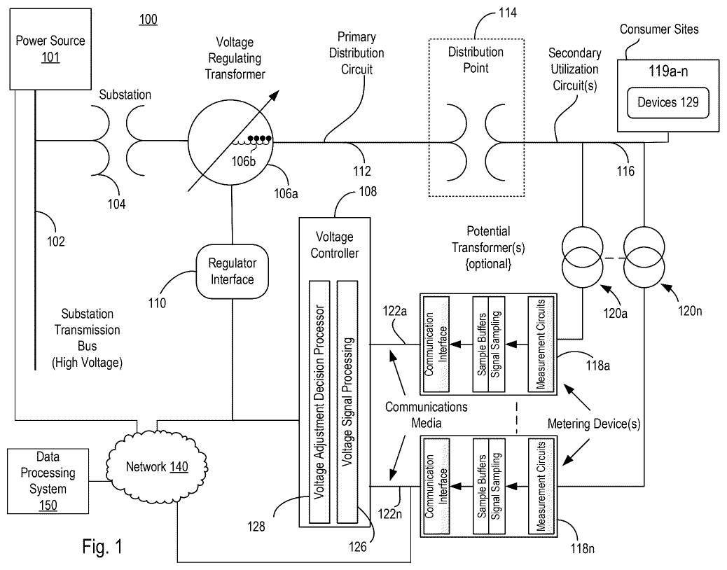

FIG. 1 depicts an example utility distribution environment. The utility distribution environment can include a utility grid 100. The utility grid 100 can include an electricity distribution grid with one or more devices, assets, or digital computational devices and systems, such as a data processing system 150. In brief overview, the utility grid 100 includes a power source 101 that can be connected via a subsystem transmission bus 102 and/or via substation transformer 104 to a voltage regulating transformer 106a. The voltage regulating transformer 106a can be controlled by voltage controller 108 with regulator interface 110. Voltage regulating transformer 106a can be optionally coupled on primary distribution circuit 112 via optional distribution transformer 114 to secondary utilization circuits 116 and to one or more electrical or electronic devices 129. Voltage regulating transformer 106a can include multiple tap outputs 106b with each tap output 106b supplying electricity with a different voltage level. The utility grid 100 can include monitoring devices 118a-118n that can be coupled through optional potential transformers 120a-120n to secondary utilization circuits 116. The monitoring or metering devices 118a-118n can detect (e.g., continuously, periodically, based on a time interval, responsive to an event or trigger) measurements and continuous voltage signals of electricity supplied to one or more electrical devices 129 connected to circuit 112 or 116 from a power source 101 coupled to bus 102. These metering devices 118a-118n, among other components within utility distribution grids, can collect samples of power delivery or consumption, such as voltage information, at a predetermined sample rate. A voltage controller 108 can receive, via a communication media 122, measurements obtained by the metering devices 118a-118n, and use the measurements to make a determination regarding a voltage tap settings, and provide an indication to regulator interface 110. The regulator interface can communicate with voltage regulating transformer 106a to adjust an output tap level 106b.

In FIG. 1, in further detail, the utility grid 100 includes a power source 101. The power source 101 can include a power plant such as an installation configured to generate electrical power for distribution. The power source 101 can include an engine or other apparatus that generates electrical power. The power source 101 can create electrical power by converting power or energy from one state to another state. In some embodiments, the power source 101 can be referred to or include a power plant, power station, generating station, powerhouse or generating plant. In some embodiments, the power source 101 can include a generator, such as a rotating machine that converts mechanical power into electrical power by creating relative motion between a magnetic field and a conductor. The power source 101 can use one or more energy source to turn the generator including, e.g., fossil fuels such as coal, oil, and natural gas, nuclear power, or cleaner renewable sources such as solar, wind, wave and hydroelectric.

In some embodiments, the utility grid 100 includes one or more substation transmission bus 102. The substation transmission bus 102 can include or refer to transmission tower, such as a structure (e.g., a steel lattice tower, concrete, wood, etc.), that supports an overhead power line used to distribute electricity from a power source 101 to a substation 104 or distribution point 114. Transmission towers 102 can be used in high-voltage AC and DC systems, and come in a wide variety of shapes and sizes. In an illustrative example, a transmission tower can range in height from 15 to 55 meters or more. Transmission towers 102 can be of various types including, e.g., suspension, terminal, tension, and transposition. In some embodiments, the utility grid 100 can include underground power lines in addition to or instead of transmission towers 102.

In some embodiments, the utility grid 100 includes a substation 104 or electrical substation 104 or substation transformer 104. A substation can be part of an electrical generation, transmission, and distribution system. In some embodiments, the substation 104 transform voltage from high to low, or the reverse, or performs any of several other functions to facilitate the distribution of electricity. In some embodiments, the utility grid 100 can include several substations 104 between the power plant 101 and the consumer electoral devices 129 within sites 119 with electric power flowing through them at different voltage levels.

The substations 104 can be remotely operated, supervised and controlled (e.g., via a supervisory control and data acquisition system or data processing system 150). A substation can include one or more transformers to change voltage levels between high transmission voltages and lower distribution voltages, or at the interconnection of two different transmission voltages.

The regulating transformer 106 can include: (1) a multi-tap autotransformer (single or three phase), which are used for distribution; or (2) on-load tap changer (three phase transformer), which can be integrated into a substation transformer 104 and used for both transmission and distribution. The illustrated system described herein can be implemented as either a single-phase or three-phase distribution system. The utility grid 100 can include an alternating current (AC) power distribution system and the term voltage can refer to an “RMS Voltage”, in some embodiments.

The utility grid 100 can include a distribution point 114 or distribution transformer 114, which can refer to an electric power distribution system. In some embodiments, the distribution point 114 can be a final or near final stage in the delivery of electric power. For example, the distribution point 114 can carry electricity from the transmission system (which can include one or more transmission towers 102) to individual consumers or consumer sites 119 that can include various electrical or electronic devices 129. In some embodiments, the distribution system can include the substations 104 and connect to the transmission system to lower the transmission voltage to medium voltage ranging between 2 kV and 35 kV with the use of transformers, for example. Primary distribution lines or circuit 112 carry this medium voltage power to distribution transformers located near the customer's premises or sites 119. Distribution transformers can further lower the voltage to the utilization voltage of appliances and can feed several customers 119 through secondary distribution lines or circuits 116 at this voltage. Commercial and residential customers 119 can be connected to the secondary distribution lines through service drops. In some embodiments, customers demanding high load can be connected directly at the primary distribution level or the sub-transmission level.

The utility grid 100 can include or couple to one or more consumer sites 119. Consumer sites 119 can include, for example, a building, house, shopping mall, factory, office building, residential building, commercial building, stadium, movie theater, etc. The consumer sites 119 can be configured to receive electricity from the distribution point 114 via a power line (above ground or underground). A consumer site 119 can be coupled to the distribution point 114 via a power line. The consumer site 119 can be further coupled to a site meter 118a-n or advanced metering infrastructure (AMI). The site meter 118a-n can be associated with a controllable primary circuit segment 112. The association can be stored as a pointer, link, field, data record, or other indicator in a data file in a database.

The utility grid 100 can include site meters 118a-n or AMI. Site meters 118a-n can measure, collect, and analyze energy usage, and communicate with metering devices such as electricity meters, gas meters, heat meters, and water meters, either on request or on a schedule. Site meters 118a-n can include hardware, software, communications, consumer energy displays and controllers, customer associated systems, Meter Data Management (MDM) software, or supplier business systems. In some embodiments, the site meters 118a-n can obtain samples of electricity usage in real time or based on a time interval, and convey, transmit or otherwise provide the information. In some embodiments, the information collected by the site meter can be referred to as meter observations or metering observations and can include the samples of electricity usage. In some embodiments, the site meter 118a-n can convey the metering observations along with additional information such as a unique identifier of the site meter 118a-n, unique identifier of the consumer, a time stamp, date stamp, temperature reading, humidity reading, ambient temperature reading, etc. In some embodiments, each consumer site 119 (or electronic device) can include or be coupled to a corresponding site meter or monitoring device 118a-118n.

Monitoring devices 118a-118n can be coupled through communications media 122a-122n to voltage controller 108. Voltage controller 108 can compute (e.g., discrete-time, continuously or based on a time interval or responsive to a condition/event) values for electricity that facilitates regulating or controlling electricity supplied or provided via the utility grid. For example, the voltage controller 108 can compute estimated deviant voltage levels that the supplied electricity (e.g., supplied from power source 101) will not drop below or exceed as a result of varying electrical consumption by the one or more electrical devices 129. The deviant voltage levels can be computed based on a predetermined confidence level and the detected measurements. Voltage controller 108 can include a voltage signal processing circuit 126 that receives sampled signals from metering devices 118a-118n. Metering devices 118a-118n can process and sample the voltage signals such that the sampled voltage signals are sampled as a time series (e.g., uniform time series free of spectral aliases or non-uniform time series).

Voltage signal processing circuit 126 can receive signals via communications media 122a-n from metering devices 118a-n, process the signals, and feed them to voltage adjustment decision processor circuit 128. Although the term “circuit” is used in this description, the term is not meant to limit this disclosure to a particular type of hardware or design, and other terms known generally known such as the term “element”, “hardware”, “device” or “apparatus” could be used synonymously with or in place of term “circuit” and can perform the same function. For example, in some embodiments the functionality can be carried out using one or more digital processors, e.g., implementing one or more digital signal processing algorithms. Adjustment decision processor circuit 128 can determine a voltage location with respect to a defined decision boundary and set the tap position and settings in response to the determined location. For example, the adjustment decision processing circuit 128 in voltage controller 108 can compute a deviant voltage level that is used to adjust the voltage level output of electricity supplied to the electrical device. Thus, one of the multiple tap settings of regulating transformer 106 can be continuously selected by voltage controller 108 via regulator interface 110 to supply electricity to the one or more electrical devices based on the computed deviant voltage level. The voltage controller 108 can also receive information about voltage regulator transformer 106a or output tap settings 106b via the regulator interface 110. Regulator interface 110 can include a processor controlled circuit for selecting one of the multiple tap settings in voltage regulating transformer 106 in response to an indication signal from voltage controller 108. As the computed deviant voltage level changes, other tap settings 106b (or settings) of regulating transformer 106a are selected by voltage controller 108 to change the voltage level of the electricity supplied to the one or more electrical devices 119.

The network 140 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 1G, 2G, 3G, or 4G. The network standards can qualify as one or more generation of mobile telecommunication standards by fulfilling a specification or standards such as the specifications maintained by International Telecommunication Union. The 3G standards, for example, can correspond to the International Mobile Telecommunications-2000 (IMT-2000) specification, and the 4G standards can correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards can use various channel access methods e.g. FDMA, TDMA, CDMA, or SDMA. In some embodiments, different types of data can be transmitted via different links and standards. In other embodiments, the same types of data can be transmitted via different links and standards.

The network 140 can be any type and/or form of network. The geographical scope of the network 140 can vary widely and the network 140 can be a body area network (BAN), a personal area network (PAN), a local-area network (LAN), e.g. Intranet, a metropolitan area network (MAN), a wide area network (WAN), or the Internet. The topology of the network 140 can be of any form and can include, e.g., any of the following: point-to-point, bus, star, ring, mesh, or tree. The network 140 can be an overlay network which is virtual and sits on top of one or more layers of other networks 140. The network 140 can be of any such network topology as known to those ordinarily skilled in the art capable of supporting the operations described herein. The network 140 can utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite can include application layer, transport layer, internet layer (including, e.g., IPv6), or the link layer. The network 140 can be a type of a broadcast network, a telecommunications network, a data communication network, or a computer network.

The network 140 can include computer networks such as the internet, local, wide, near field communication, metro or other area networks, as well as satellite networks or other computer networks such as voice or data mobile phone communications networks, and combinations thereof. The network 140 can include a point-to-point network, broadcast network, telecommunications network, asynchronous transfer mode network, synchronous optical network, or a synchronous digital hierarchy network, for example. The network 140 can include at least one wireless link such as an infrared channel or satellite band. The topology of the network 140 can include a bus, star, or ring network topology. The network 140 can include mobile telephone or data networks using any protocol or protocols to communicate among vehicles or other devices, including advanced mobile protocols, time or code division multiple access protocols, global system for mobile communication protocols, general packet radio services protocols, or universal mobile telecommunication system protocols, and the same types of data can be transmitted via different protocols.

One or more components, assets, or devices of utility grid 100 can communicate via network 140. The utility grid 100 can use one or more networks, such as public or private networks. The utility grid 100 can communicate or interface with a data processing system 150 designed and constructed to communicate, interface or control the utility grid 100 via network 140. Each asset, device, or component of utility grid 100 can include one or more computing devices 500 or a portion of computing device 500 or some or all functionality of computing device 500.

The data processing system 150 can reside on a computing device of the utility grid 100, or on a computing device or server external from, or remote from the utility grid 100. The data processing system 150 can reside or execute in a cloud computing environment or distributed computing environment. The data processing system 150 can reside on or execute on multiple local computing devices located throughout the utility grid 100. For example, the utility grid 100 can include multiple local computing devices each configured with one or more components or functionality of the data processing system 150.

Each of the components of the data processing system 150 can be implemented using hardware or a combination of software and hardware. Each component of the data processing system 150 can include logical circuitry (e.g., a central processing unit or CPU) that responses to and processes instructions fetched from a memory unit (e.g., memory 815 or storage device 825). Each component of the data processing system 150 can include or use a microprocessor or a multi-core processor. A multi-core processor can include two or more processing units on a single computing component. Each component of the data processing system 150 can be based on any of these processors, or any other processor capable of operating as described herein. Each processor can utilize instruction level parallelism, thread level parallelism, different levels of cache, etc. For example, the data processing system 150 can include at least one logic device such as a computing device or server having at least one processor to communicate via the network 140.

The components and elements of the data processing system 150 can be separate components, a single component, or part of the data processing system 150. For example, individual components or elements of the data processing system 150 can operate concurrently to perform at least one feature or function discussed herein. In another example, components of the data processing system 150 can execute individual instructions or tasks. The components of the data processing system 150 can be connected or communicatively coupled to one another. The connection between the various components of the data processing system 150 can be wired or wireless, or any combination thereof. Counterpart systems or components can be hosted on other computing devices.

The data processing system 150 can communicate with one or more metering devices 118 via the network 140. In some cases, the data processing system 150 can include features or functionalities of the metering devices 118. In some other cases, the data processing system 150 can be a part of the metering device 118, such that the metering device 118 can perform certain features or functionalities of the data processing system 150. For purposes of providing examples, the data processing system 150 can include, correspond to, or be a part of at least one metering device 118 associated with an entity (e.g., residential area or home), configured to perform the features, techniques, or operations to disaggregate solar voltaic from the metered net load.

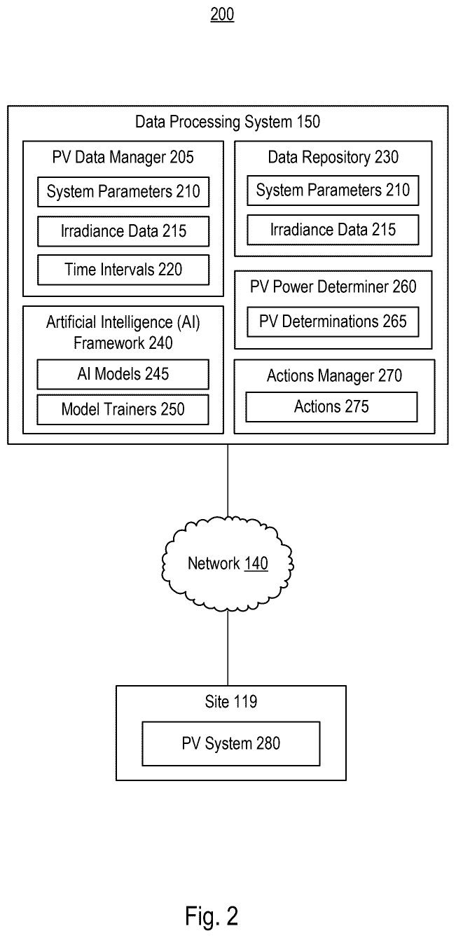

FIG. 2 illustrates an example system 200 for providing photovoltaic power disaggregation from metered net-load. Example system 200 can include one or more data processing systems 150 that can be coupled, via one or more networks 140, with one or more sites 119 that include one or more photovoltaic (PV) systems 280 (e.g., a system of one or more solar panels creating electricity from solar energy). The one or more data processing systems 150 can include one or more of: photovoltaic (PV) data managers 205, data repositories 230, artificial intelligence (AI) frameworks 240, PV power determiners 260 and action managers 270. A PV data manager can identify, access or include one or more of system parameters 210 and irradiance data 215 corresponding to time intervals 220. A data repository 230 can store and provide access to various data, such as system parameters 210 and irradiance data 215 acquired by the PV data manager 205. An AI framework 240 can include one or more AI models 245 trained using one or more model trainers 250 to perform actions on behalf of the PV data manager 205 or the PV power determiner 260. A PV power determiner 260 can generate or provide PV determinations 265, such as a PV power amount generated by a PV system 280 based on the system parameters 210 and irradiance data 215 for a given time interval 220 and for the PV system 280 at a given site 119. An actions manager 270 can include actions 275 (e.g., related to power delivery for the site 119 of the PV system 280) based on the PV determinations 265.

For example, a photovoltaic (PV) data manager 205 can be configured to utilize one or more AI models 245 to identify, access or acquire system parameters 210, such as parameters on tilt, azimuth or capacity factors for a PV system 280 at a site 119. The PV data manager 205 can utilize the one or more AI models 245 to receive, access or acquire (e.g., from a data repository 230) irradiance data 215 for computing the amount of solar energy received by the solar panels of the PV system 280 for one or more time intervals 220. The PV power determiner 260 can utilize the system parameters 210 and the irradiance data 215 for a given time interval 220 to make one or more PV determinations 265 (e.g., the amount of electricity the PV system 280 is to generate or output from the solar energy over the given time interval 220). The actions manager 270 can, responsive to the one or more PV determinations 265, execute one or more actions related to power or electricity delivery to the site 119 of the PV system 280 for the given time interval 220.

Data processing system 150 can include any combination of hardware and software for providing PV disaggregation from metered net-load. The disaggregation from metered net-load can include any process of separating or isolating the power generated by one or more photovoltaic (PV) systems from the total power consumption or delivery measured by utility meters. This can include using data analysis and modeling techniques to accurately estimate the amount of solar power generated by PV systems, distinguishing such PV system generated power from the overall net-load, with respect to either energy consumption or generation. The data processing system 150 can provide the disaggregation from metered net-load to help utilities understand the contribution of solar power to the grid and manage power distribution more effectively (e.g., reduce losses or inefficiencies in the grid system).

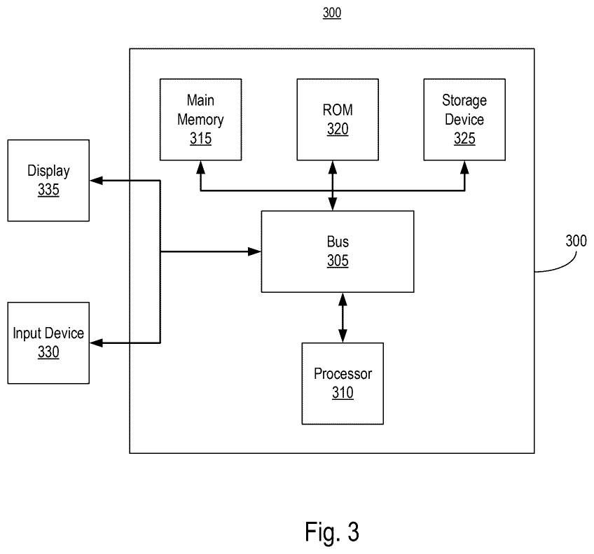

The data processing system 150 can be deployed at one or more physical or virtual servers, computing devices, such as the one shown in FIG. 3, a cloud-based system, or a software as a service platform. The data processing system 150 can include various components, such as PV data manager 205, data repositories 230, AI frameworks 240, PV power determiners 260, and actions managers 270. The data processing system 150 can be responsible for managing and analyzing data related to photovoltaic systems 280 at different sites 119. The data processing system 150 can process historical and real-time data, including system parameters 210 and irradiance data 215, to generate accurate PV determinations 265. By leveraging AI models 245, the data processing system 150 can improve the accuracy and efficiency of PV power estimation. For example, the data processing system 150 can use machine learning techniques to predict power output and optimize grid operations. The data processing system 150 can execute actions 275 based on PV determinations 265 to maintain grid stability and optimize power distribution. The data processing system 150 can include one or more processors (e.g., 310) coupled with memory (e.g., 315) and can be located at the site 119 or at a grid system device remote from the site 119.

PV data manager 205 can be any combination of hardware and software for identifying, receiving, or managing data corresponding to photovoltaic systems. The PV data manager 205 can include any functionality (e.g., computer code, instructions, or data) to identify, access, or acquire data, such as system parameters 210, which can include, for example, information on tilt, azimuth, and capacity factors for a PV system 280 at a given site 119. The PV data manager 205 can utilize AI models 245 to receive, access, or acquire irradiance data from a data repository 230 or any other information source (e.g., satellite weather data or a remote weather information database). PV data manager 205 can also check that the received data (e.g., system parameters 210 or irradiance data 215) is timestamped or timestamp-matched and relevant for the given time interval 220. For example, PV data manager 205 can use historical net-load data to improve the accuracy of PV power generation estimates. For example, PV data manager 205 can integrate real-time weather data to improve the precision of irradiance related computations.

PV data manager 205 can utilize the system parameters 210 and irradiance data 215 to determine or infer further information that can be used for determining PV determinations 265. For instance, the PV data manager 205 can determine an in-plane irradiance based on the data, such as irradiance data, the tilt and the azimuth. The in-plane irradiance can be the total solar radiation received by a solar panel accounting for the solar panel's tilt and orientation. The PV data manager 205 can operate with the PV power determiner 260 to determine the amount of power generated by the PV system 280 based on the in-plane irradiance and the capacity factor (e.g., the ratio of the actual output of the PV system over a period of time relative to the potential output of the same PV system if it had operated at full capacity for the same period).

The PV data manager 205 can identify geographic coordinates for a site 119 and transmit, using an application programming interface (API) call, via a network 140, a request for the irradiance data 215. The request for the irradiance data 215 can include or correspond to geographic coordinates for the site 119 and an indication of the first time interval 220. The PV data manager 205 can receive the irradiance data responsive to the request. The irradiance data 215 can include one or more of: a direct normal irradiance, a diffuse horizontal irradiance, or a global horizontal irradiance.

System parameters 210 can include any parameters, values, or variables that can be used for determining the power output of a photovoltaic system 280. Examples of system parameters 210 can include tilt, azimuth, capacity factors, elevation of the site 119, panel efficiencies of the PV system 280, temperature coefficients at the site 119, shading factors, inverter efficiencies, panel degradation rates, albedo (e.g., surface reflectivity), solar panel orientations, mounting types, array configurations, or system losses (e.g., loses due to PV system inverters and other electrical or electronic components). System parameters 210 can be used to compute the amount of power generated by a PV system 280 given the location, weather, conditions, configurations or shape of the PV system 280. The PV data manager 205 can identify and access system parameters 210 using AI models 245. The system parameters 210 can be used to create reliable AI models 245 for PV power generation, including for example, training of AI models 245 by the model trainer 250 based on the system parameters 210 or irradiance data 215 that can be used as training set data.

Irradiance data 215 can include values or measurements of solar energy received at a specific location, such as a site 119 at which PV system 280 is deployed. Irradiance data 215 can include, for example, Direct Normal Irradiance (DNI), Diffuse Horizontal Irradiance (DHI), or Global Horizontal Irradiance (GHI). The irradiance data 215 can reflect, correspond to, or include, clear-sky irradiance, actual or real-time weather conditions, satellite imagery data, current weather conditions, solar elevation angles, solar azimuth angles, temperature, humidity, and cloud cover. The PV data manager 205 can acquire the irradiance data 215 from a data repository 230 or other sources, such as satellite imagery. Irradiance data 215 can be used to compute, predict or determine the amount of solar energy available for power generation at a particular location or area. Using irradiance data 215, the data processing system 150 can determine a reliable PV output for the given conditions at a given PV system 280. For example, irradiance data 215 can be used to account for shading and cloud coverage effects on solar panels, improving the accuracy of PV determinations 265 by the PV power determiner 260.

Time intervals 220 can include any time periods for a given data. Time intervals 220 can include time durations or period for which data is collected or analyzed. Time intervals 220 can correspond to any time durations, such as one or more seconds, one or more minutes, one or more hours or one or more days. Time intervals 220 can be defined based on the use by the data processing system 150. For example, time intervals 220 can be set to match a sampling rate of net-load measurements, such as every 15 to 60 minutes. Time intervals 220 can be used to check that the data used for PV power estimation is relevant and consistent with respect to the PV system 280 for which the determination is made. The PV data manager 205 can use time intervals 220 to synchronize system parameters 210 and irradiance data 215, including using timestamping. Such synchronization can facilitate creating accurate models for PV power generation or produce reliable PV determinations 265. For instance, using consistent time intervals 220 can improve the reliability of historical data analysis and real-time power generation estimates.

Data repository 230 can include any system for storing data, including any storage that holds various types of data used for PV power disaggregation. Data repository 230 can store system parameters 210, irradiance data 215, historical net-load data, weather data, satellite imagery, solar position data, and other relevant information. The data repository 230 can provide access to this data for the PV data manager 205 and other components. By maintaining a centralized storage, the data repository 230 ensures data consistency and availability for various components of the data processing system 150. For example, data repository 230 can store historical irradiance data 215 that the PV data manager 205 can use to train AI models 245. Data repository 230 can facilitate data sharing across different components of the system.

Artificial intelligence (AI) framework 240 can include any combination of tools, functions or code for providing artificial intelligence or machine learning (ML) functionalities. The AI framework 240 can include a set of tools and libraries used to develop and deploy artificial intelligence models 245. The AI framework 240 can include any number of AI models 245 trained one any number or types of datasets, including any system parameters 210 or irradiance data 215 for any number of PV systems 280 on any number of sites 119. The AI models 245 can be trained to perform specific tasks related to PV power disaggregation, such as determining amount of PV power output from a given site 119, based on the PV systems 280 used and deployed at that location. The AI framework 240 can support model training, validation, and deployment. By using an AI framework 240, the system can leverage advanced machine learning techniques to improve accuracy of the PV determinations 265. For example, the AI framework 240 can include AI models 245 for identifying system parameters 210 and predicting PV power output for a PV system 280 at a given site 119, based on the conditions, configurations or data of that PV system 280 (e.g., energy losses, efficiencies of the solar panels, variations in performance between the individual solar panels, types of inverters and PV power management circuitry utilized or any other information or data specific to the PV system 280).

AI models 245 can include any machine learning models trained to perform specific tasks within the PV power disaggregation system. AI models 245 can be trained using historical data, such as any combination of net-load measurements, system parameters 210 data or irradiance data 215. AI models 245 can be used to identify system parameters 210, generate PV determinations 265 (e.g., predict PV power output), and optimize system performance (e.g., matching of the power managed for the site 119 based on the PV output of the PV system 280 in view of the PV determinations 265 for the site 119). For example, an AI model 245 can be trained to estimate the tilt and azimuth of solar panels based on historical data or data of other sites 119 and utilizing geolocation data. By using AI models 245, the system can achieve improved accuracy and efficiency in PV power estimation. The AI models 245 can continuously learn and improve from new data, improving their predictive capabilities over time.

AI models 245 can include a wide range of ML or AI techniques to enhance the PV power disaggregation system. For instance, generative AI models can utilize prompts created from system parameters 210 and irradiance data 215 to generate specific PV determinations 265, such as predicting power output under varying conditions. AI models 245 can identify, access, or acquire specific types of system parameters 210 or irradiance data 215 for a given PV system 280 at a given location. For instance, convolutional neural networks (CNNs) can be used to analyze satellite imagery and weather data to estimate irradiance levels. Recurrent neural networks (RNNs) can process time-series data to predict future PV power output based on historical trends. Decision trees and random forests can be employed to classify and predict system performance under different environmental conditions. Support vector machines (SVMs) can be used for regression tasks to estimate the capacity factor of PV systems. Ensemble learning techniques can combine multiple models to improve overall prediction accuracy. Reinforcement learning models can optimize the operation of PV systems by learning from real-time data and adjusting parameters to maximize efficiency. Using such AI models 245, the data processing system 150 can achieve robust and accurate PV power disaggregation, improving performance and grid stability.

Model trainers 250 can include any components or tools for training AI models 245. Model trainers 250 can use historical data to train models for specific tasks, such as identifying system parameters 210 or predicting PV power output. Model trainers 250 can perform tasks like data preprocessing, model selection, and hyperparameter tuning. Training can be performed by splitting the historical data into training and validation sets to evaluate model performance. Techniques such as cross-validation can be used to ensure the model generalizes well to unseen data. Model trainer 250 can train AI models 245 for any one or more PV systems 280 or any one or more sites 119 on which PV systems 280 are deployed or provided. Model trainer 250 can train an AI model 245 using supervised or unsupervised learning, labeled data, or any other techniques. Data augmentation methods can be applied to increase the diversity of the training data, improving model robustness. By training AI models 245, model trainers 250 help improve the accuracy and reliability of the system. For example, a model trainer 250 can use historical irradiance data 215 to train a model for predicting PV power generation. This training process can be used to check that the models can adapt to changing conditions. For instance, the model trainer 250 can train an AI model 245 for a site 119 based on one or more geographic coordinates for the site 119, an elevation of the site 119, and timeseries data comprising historical base-adjusted net-load data for the site 119, historical irradiance data for the site 119, and solar position data for the site 119.

PV power determiner 260 can include any combination of hardware and software for making determinations about a PV system 280. PV power determiner 260 can include the functionalities (e.g., computer code, instructions or data) for computing power generated by a certain photovoltaic system 280 based on the system parameters 210 and irradiance data 215 for that particular PV system 280. The PV power determiner 260 can use an AI model 245 to utilize parameters 210 and irradiance data 215 to make PV determinations 265. The PV power determiner 260 can generate PV determinations 265, such as the amount of electricity generated by the PV system 280 over a given time interval 220. By determining PV power output, the PV power determiner 260 can facilitate maintaining grid stability and optimizing power delivery. For example, the PV power determiner 260 can use tilt, azimuth, and irradiance data 215 to estimate the PV output for a specific site 119 for a given time interval 220, and use this PV output take an action 275 (e.g., by the actions manager 270) to offset the amount of electricity provided to the site 119.

PV determinations 265 can include any determinations associated with a PV system 280 at a particular site 119. PV determination 265 can include any results of determinations, computations, or calculations related to photovoltaic power generation from a given PV system 280 based on the system parameters 210 or irradiance data 215 for that PV system 280 or its site 119. PV determinations 265 can include any number of determinations associated with a PV system 280. For instance, a PV determination 265 can include an amount of electricity that the PV power determiner 260 can generate by a PV system 280 over a given time interval 220. PV determination 265 can include any determination corresponding to an amount of voltage, current, power, resistance or impedance, load input or output, phase or amplitude signal output. PV determination 265 can include a capacity factor for a PV system 280, including for example, a determined ratio of an actual output of a photovoltaic system 280 over a period of time, relative to a potential output of the same system if it had operated at full capacity for the same period. For example, PV determinations 265 can include the estimated power output during peak sunlight hours, the expected reduction in power output due to shading, the impact of temperature variations on power generation, the efficiency of the PV system 280 over time, the comparison of actual versus predicted power output, and the identification of potential faults or inefficiencies in the PV system 280. PV determinations 265 can be made by analyzing historical net-load data, applying machine learning models to predict future power output, or using real-time irradiance data to adjust predictions. PV determinations 265 can be used to plan for reserve power resources, optimize (e.g., reduce energy losses during) grid operations, or provide stable power delivery to the site 119 or the grid.

PV power determiner 260 can make various determinations related to PV system 280. For instance, PV power determiner 260 can identify historical net-load time series data for the site and determine a base load for the site. The base load can correspond to a minimum load present at each time stamp in the historical net-load time series data. The PV power determiner 260 can generate the historical base-adjusted net-load data based on a difference between a net-load for the site and the base load time series data for the site 119. For example, the PV power determiner 260 can generate historical in-plane irradiance time series data for the site based on the historical irradiance data and the solar position data. The PV power determiner 260 can generate minimum capacity factor time series data based on the historical base-adjusted net-load data and the historical in-plane irradiance time series data. The PV power determiner 260 can determine the capacity factor for the photovoltaic system at the site based on a percentile range of the minimum capacity factor time series data. For example, the PV power determiner 260 can select the tilt and the azimuth for the capacity factor that corresponds to a minimum value of the minimum capacity factor time series data within the percentile range.

Actions manager 270 can include any combination of hardware and software for component responsible for executing actions based on PV determinations 265. The actions manager 270 can manage actions related to power delivery, such as adjusting voltage tap settings, setting amount of electricity delivered or received from a site of the PV system 280 or activating circuits for the grid for managing electricity in response to PV output from the PV system 280. The actions manager 270 can use PV determinations 265 to make informed decisions and execute appropriate actions. By managing these actions, the actions manager 270 can facilitate maintaining grid stability and optimizing power distribution (e.g., reducing energy losses in the grid during operation). For example, the actions manager 270 can adjust power delivery based on the estimated PV output to prevent reverse power flow. This proactive management can improve the efficiency and reliability of the electricity distribution grid.

Actions 275 can include any operations corresponding to power delivery and grid management. Actions 275 can include operations executed (e.g., by the grid system) based on PV determinations 265 to maintain grid stability and optimize power distribution (e.g., reduce energy losses in the grid system). For instance, action 275 can include adjusting voltage tap settings to maintain voltage levels within acceptable limits, preventing issues such as overvoltage or undervoltage. An action 275 can include setting the amount of electricity delivered to or received from a site 119 of the PV system 280, to ensure that the power flow is balanced and efficient. An action 275 can include activating circuits for the grid to manage electricity in response to PV output from the PV system 280, helping to distribute power where it is needed most. An action 275 can include activating or deactivating capacitors to manage reactive power and improve power factor, to improve the efficiency of the grid. Actions manager 270 can initiate load shedding or load shifting to balance demand and supply, such as during periods of high PV output. An action 275 can include adjusting the charging or discharging rates of battery energy storage systems to store excess PV power or provide additional power during low generation periods.

Actions manager 270 can control the operation of electric vehicle chargers, adjusting their power delivery based on the available PV output to optimize energy usage. Actions 275 can include sending alerts or notifications to grid operators about potential issues or to request interventions or maintenance based on PV determinations 265 (e.g., that there is an error or an issue at the PV system 280). The actions manager 270 can execute demand response actions, such as incentivizing consumers to reduce or shift their energy usage during peak PV generation times. Actions 275 can involve updating grid management software or algorithms to incorporate new data and improve future decision-making processes.

A site 119 can be any location that includes one or more photovoltaic (PV) systems 280. A site 119 can be a location having a PV system 280 that is electrically coupled with an electricity distribution grid. A site 119 can include various characteristics, such as geographic coordinates and elevation that are unique from other sites 119. The site 119 can be monitored and managed by the data processing system 150 to adjust, manage or optimize PV power generation and grid stability and efficiency. For example, a site 119 can include a residential area with rooftop solar panels, or a solar farm with hundreds or thousands of solar panels.

Photovoltaic (PV) system 280 can include any system having one or more photovoltaic panels or devices for generating electricity from solar energy. A PV system 280 can include solar panels arranged in arrays and connected via various electrical systems, including for example, inverters and monitoring circuits, for generating electricity from solar energy and providing such generated electricity to a utility grid. PV systems 280 can be installed at various sites 119 and can be monitored and managed by various meters and monitoring circuits or devices, as well as by a data processing system 150 coupled with such circuits or devices. The PV system 280 can have specific system parameters 210, such as tilt, azimuth, and capacity factor, which can be used to estimate power generation. By accurately estimating PV output, the system can optimize power delivery and maintain grid stability. For example, a PV system 280 at a residential site 119 can provide electricity to the home and contribute to the overall grid. This integration of PV systems 280 into the grid can enhance the sustainability and resilience of the electricity distribution network.

The actions manager 270 can determine any actions 275 with respect to the site or its PV system 280. For example, the action manager 270 can compare the amount of power (e.g., PV determination 265 of amount of PV power) generated by the PV system 280 during the first time interval (e.g., 220) with a threshold. The threshold can be a predetermined amount of power for the PV system. The PV actions manager 270 can determine, based on the comparison, to adjust a voltage tap setting on the electricity distribution grid. The PV actions manager 270 can execute the action 275 to adjust the voltage tap setting, responsive to the determination. For instance, the actions manager 270 can compare the amount of power generated by the photovoltaic system during the first time interval with a threshold and determine, based on the comparison, to activate one or more capacitors on the electricity distribution grid. The PV actions manager 270 can execute the action 275 to activate the one or more capacitors on the electricity distribution grid. For instance, the actions manager 270 can determine, based on the amount of power generated by the photovoltaic system during the first time interval, to adjust power delivery by an electric vehicle charger at the site 119. The actions manager 270 can execute the action to adjust the power delivery by the electric vehicle charger at the site responsive to the determination. For instance, the actions manager 270 can determine, based on the amount of power (e.g., PV determination 265) generated by the PV system 280 during the first time interval, to adjust power delivery by a battery energy storage system at the site 119. The actions manager 270 can execute the action to adjust the power delivery by the battery energy storage system at the site, responsive to this determination.

FIG. 3 is a block diagram of an example computer system 300. The computer system or computing device 300 can include or be used to implement the data processing system 150, or its components. The computing system 300 includes at least one bus 305 or other communication component for communicating information and at least one processor 310 or processing circuit coupled to the bus 305 for processing information. The computing system 300 can also include one or more processors 310 or processing circuits coupled to the bus for processing information. The computing system 300 also includes at least one main memory 315, such as a random access memory (RAM) or other dynamic storage device, coupled to the bus 305 for storing information, and instructions to be executed by the processor 310. The main memory 315 can also be used for storing position information, utility grid data, command instructions, device status information, environmental information within or external to the utility grid, information on characteristics of electricity, or other information during execution of instructions by the processor 310. The computing system 300 may further include at least one read only memory (ROM) 320 or other static storage device coupled to the bus 305 for storing static information and instructions for the processor 310. A storage device 325, such as a solid state device, magnetic disk or optical disk, can be coupled to the bus 305 to persistently store information and instructions.

The computing system 300 may be coupled via the bus 305 to a display 335, such as a liquid crystal display, or active matrix display, for displaying information to a user such as an administrator of the data processing system or the utility grid. An input device 330, such as a keyboard or voice interface may be coupled to the bus 305 for communicating information and commands to the processor 310. The input device 330 can include a touch screen display 335. The input device 330 can also include a cursor control, such as a mouse, a trackball, or cursor direction keys, for communicating direction information and command selections to the processor 310 and for controlling cursor movement on the display 335. The display 335 can be part of the data processing system 150, or other components of FIGS. 1-2, among others.

The processes, systems, and methods described herein can be implemented by the computing system 300 in response to the processor 310 executing an arrangement of instructions contained in main memory 315. Such instructions can be read into main memory 315 from another computer-readable medium, such as the storage device 325. Execution of the arrangement of instructions contained in main memory 315 causes the computing system 300 to perform the illustrative processes described herein. One or more processors in a multi-processing arrangement may also be employed to execute the instructions contained in main memory 315. Hard-wired circuitry can be used in place of or in combination with software instructions together with the systems and methods described herein. Systems and methods described herein are not limited to any specific combination of hardware circuitry and software.

Although an example computing system has been described in FIG. 3, the subject matter including the operations described in this specification can be implemented in other types of digital electronic circuitry, or in computer software, firmware, or hardware, including the structures disclosed in this specification and their structural equivalents, or in combinations of one or more of them.

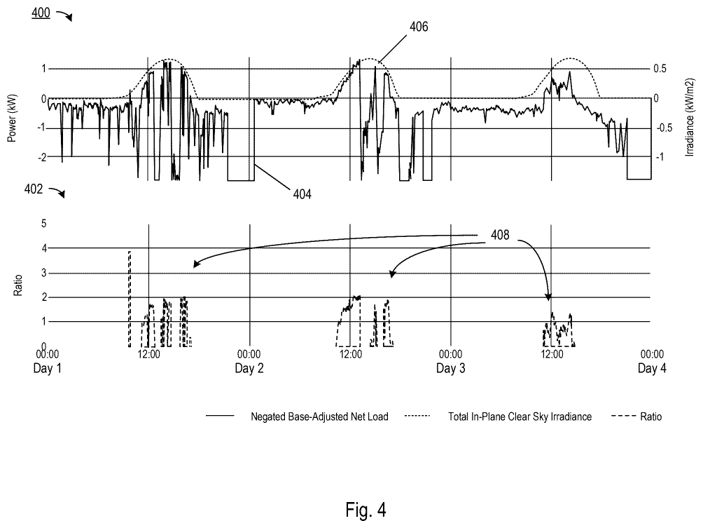

FIG. 4 depicts an example graph 400 of irradiance and negated based-adjusted net load and an example graph 402 of the minimum capacity factor computed from the irradiance and the negated based-adjusted net load, in accordance with an implementation. The graph 402 can include the computed negated base-adjusted net load (e.g., negative of the base-adjusted net load, which is the net load minus the base load) (404) and the total in-plane clear sky irradiance (e.g., the estimate of total irradiance captured by the PV) (406). The total in-plane clear sky irradiance can be proportional to the PV-generated power as the power generation from the PV is proportional to the irradiance directed or captured by the PV. In this case, the total in-plane clear sky irradiance (406) can represent the upper bound of the amount of irradiance that can be captured by the PV. The negated base-adjusted net load divided by the total in-plane clear sky irradiance can represent the smallest value of the constant, such that the expected PV power generation is the upper bound of the actual PV power generation.

The data processing system 150 can receive a plurality of input data having timestamps, e.g., time series of input data. The input data can include historical data stored in the metering device 118, predefined data stored, provided, or received by the data processing system 150, or data stored in the cloud (e.g., remote storage device or external database). For example, the data processing system 150 can receive or obtain input data including at least one of but not limited to a time series of net load data (e.g., the metering device 118 performing net load metering at the site or grid edge), a time series of at least one of direct normal irradiance (DNI), diffuse horizontal irradiance (DHI), or global horizontal irradiance (GHI) at the site, or a time series of solar elevation and azimuth angles at the site.

Still referring to FIG. 4, the net load data can correspond to the power demand by the site minus the power generated at the site. The DNI, DHI, and GHI can include fields related to irradiance from the sun. The DNI can include a measurement of the direct ray from the sun to the surface of the PV. The DHI can include a measurement of the solar radiation received on a horizontal surface from the sky, excluding the direct sunlight (e.g., excluding the DNI), including sunlight that has been scattered by molecules and particles in the atmosphere, such as clouds, dust, or aerosols. The DHI can include scattered radiation from the air, reflection from various sources, or diffused source that the PV absorbed, for example. The GHI can include a measurement of solar radiation received on a horizontal surface at the Earth's surface. The GHI can include both direct sunlight and diffuse sky radiation, e.g., a combination or function of the DNI and DHI, depending on the angle of the PV.

The time series of DNI, DHI, or GHI can be under clear-sky conditions (e.g., solar irradiance without any atmospheric influences) or under actual conditions (e.g., estimated from satellite imagery and current weather conditions). For the clear-sky condition, the data processing system 150 may use a clear-sky model, such that no external source of data (e.g., weather conditions) is utilized for the computation of PV power generation. For the actual condition, the data processing system 150 may utilize information from external sources, such as satellite data to determine the cloud movements, weather condition, or other factors that may affect the sunlight directed to the PV. The solar elevation and azimuth angles may be predefined. In some cases, certain input data can be obtained or measured based on at least one of the global positioning system (GPS) coordinates (e.g., to identify environmental conditions at the site), elevation, air pressure, or temperature information associated with the site. Additional features or information can be used as input, such as time series of weather features or properties of the AC voltage or current signals at the metering device 118 (e.g., harmonic content), not limited to the data discussed hereinabove.

The data processing system 150 can process the input data to output a time series of estimated PV output (e.g., generated power by the PV) having the time stamps corresponding to the input data. The operations or techniques to generate the output can be divided into multiple parts, such as training and inference parts/portions or stages, as an example. There may be two stages during the training portion, including a first stage to estimate the orientation and capacity of the PV array, and a second stage to incorporate one or more additional features discussed herein. In some cases, the training portion may be performed using the first stage without the second stage, such that the additional feature(s) may not be incorporated.

In the first training stage, the data processing system 150 can establish a window of input data, e.g., at least one of historical net load, DNI, DHI, GHI, or solar angles (e.g., elevation and azimuth angles), to use for fitting the model. These input data may be three datasets, e.g., a first data set including the historical net load, the second data set including the DNI, DHI, and/or GHI, and a third dataset including the solar angles. The timestamps of the (three) datasets can be matched or synchronized. The window of input data can be a year of data such that the dataset contains all four seasons, for example. In some configurations, the window of input data may be more than a year or less than a year. If the datasets do not have the same timestamps, the data processing system 150 can perform linear interpolation to interpolate the timestamps of the datasets to the timestamps of the net load data (or the timestamps of other datasets).

After establishing the window of input data, the data processing system 150 can determine (or estimate) a base load time series from the net load time series. The base load time series can include an estimate of the minimum load present at each timestamp. The minimum load can refer to the minimum power consumption (e.g., daily, weekly, or monthly) at the site or the residential home. To determine the base load time series, the data processing system 150 can group samples of net load into time windows of a predefined time (e.g., 24-hour length windows) based on the calendar date of the sample. In other words, the samples of net load can be divided into bins based on days. The data processing system 150 can remove or filter out data samples associated with nighttime (e.g., sometimes referred to as nighttime samples) for which GHI is zero or relatively close to zero. For each group of samples (e.g., each bin), the data processing system 150 can compute/calculate a predefined, relatively small, percentile (e.g., 10^{th} percentile) of net load for the remaining daytime samples in the group. Subsequently, data processing system 150 can construct the base load time series having the same timestamps as the historical net load time series, with a constant value for each calendar date determined by computing the predefined percentile of net load.

The data processing system 150 can utilize the base load estimate to avoid overestimation of the PV output, for instance, as any load removed when calculating the base-adjusted net load (discussed herein) may be indistinguishable from the PV generation. The PV generation can be counted as a negative load in the net load data.

Next, the data processing system 150 can compute or determine the base-adjusted net load. The data processing system 150 can compute the base-adjusted net load by subtracting the base load time series from the (historical) net load time series, e.g., the difference between the two time series. The data processing system 150 may filter the datasets discussed herein to timestamps associated with daylight time or hours by removing nighttime timestamps.

The data processing system 150 can perform a grid search to identify an optimal pair of PV panel tilt (e.g., solar elevation) and azimuth angles from various panel tilt and azimuth candidates. The panel tilt and azimuth candidates can include various panel tilts and azimuths varying in predefined degrees, e.g., each candidate incrementing (or decrementing) in 5-degree intervals (up to 80 degrees for realistic panel tilts). To perform the grid search, for example, the data processing system 150 can perform the following non-limiting operations for each pair of panel tilt and azimuth candidates.

As a first step of the grid search, the data processing system 150 can compute the total in-plane irradiance by summing, for example, a beam component, a sky diffuse component, and a ground reflected component. These components can be estimated from DNI, DHI, GHI, solar angles, and/or the panel tilt or azimuth using one or more models configured to determine the total in-plane irradiance. The data processing system 150 can compute the total in-plane irradiance for each panel tilt and azimuth candidate.

The second step of the grid search, the data processing system 150 can compute the minimum capacity factor (watts per unit irradiance) timeseries as k=[−Base-Adjusted Net Load/Total In-Plane Irradiance]. The “−Base-Adjusted Net Load” can be referred to as a negated base-adjusted net load. The “k” can denote the computed minimum capacity factor at a particular time stamp. This time series can represent the minimum value (at each time sample) that the total in-plane irradiance is to be multiplied by in order to match the negated base-adjusted net load (which is a biased estimate of the PV generation).

In the third step of the grid search, the data processing system 150 can determine the constant of proportionality (e.g., kₒₚₜ) between the negated base-adjusted net load and the total in-plane irradiance. For example, if the irradiance time series are clear-sky estimates (e.g., the PV is not obstructed by the cloud and receiving direct sunlight), the data processing system 150 can ensure that the product of kₒₚₜ with total in-plane irradiance can represent or be the upper bound of the negated base-adjusted net load at a plurality of samples. Therefore, the data processing system 150 can record kₒₚₜ as the value of k at a relatively high percentile (e.g., 97th), e.g., to account for outliers due to noise. This can be in contrast to taking the maximum value of k observed, which may be erroneous due to errors in the total in-plane irradiance.

For example, if the irradiance time series reflects the actual weather conditions (e.g., estimated from satellite imagery and weather data), such as accounting for cloud movement, rain, etc., the data processing system 150 can regress kₒₚₜ from a linear fit between total in-plane irradiance and negated base-adjusted net load. The data processing system 150 can execute or perform various steps to regress the kₒₚₜ. For instance, the data processing system 150 can select the samples of total in-plane irradiance and base-adjusted net load corresponding to values of k within a certain relatively high percentile range (e.g., between 93^{rd} and 97^{th} percentiles). For instance, the data processing system 150 can regress kₒₚₜ from the linear fit of negated base-adjusted net load against total in-plane irradiance as the independent variable. The regression (model) may (or may not) use additional independent variables. The independent variables may include but are not limited to at least one of indicator variables for a tiling of the space of solar azimuth and solar elevation (e.g., to control for horizon shading) or temperature to account for the potential thermal effects on PV efficiency. For instance, the data processing system 150 can compute or calculate the mean absolute error (MAE) of the residuals. Other types of computation techniques may be utilized, not limited to MAE. In this case, the MAE may be relatively less sensitive to outliers (e.g., frequent outliers may be expected due to spikes in site load). For instance, the data processing system 150 can save the MAE and coefficients of the regression.

For example, subsequent to performing the operations hereinabove for each pair of panel tilt and azimuth candidates, the data processing system 150 can determine, identify, or select an optimal pair of tilt and azimuth candidates. In some cases, if the irradiance time series are clear-sky estimates, the data processing system 150 can select the tilt and azimuth candidate with the smallest value of kₒₚₜ. In this case, the panel parameters that are capable of upper-bounding the negated base-adjusted net load with the smallest PV capacity can be selected, as measured by kₒₚₜ.

In some cases, if the irradiance time series reflect actual weather conditions (e.g., utilizing satellite data), the data processing system 150 can select the tilt and azimuth candidate that minimizes a weighted combination of kₒₚₜ and its corresponding MAE. In this case, the selection criterion can minimize fitting error, while using kₒₚₜ as a regularizer, for example. The data processing system 150 can save the corresponding tilt, azimuth, and kₒₚₜ. An example of kₒₚₜ can be shown in at least graph 402 of FIG. 4. As shown, the kₒₚₜ (408) can be plotted in association with the negated base-adjusted net load and the total in-plane clear sky irradiance.

In some cases, the user may have submetered PV timeseries at a small number of sites. When ground-truth PV labels are available at a subset of sites, there may be an optional second stage of the PV disaggregation model to correct for systematic errors in the first stage and/or incorporate information from additional independent variables (e.g., weather features or harmonic content of AC current at the site). In this second stage, a global model is fit against ground-truth labels from all sites where submetered PV is available.

The data processing system 150 may execute a second training stage. In the second training stage, the data processing system 150 can collect training data from various sites (e.g., a plurality of residential homes, areas, or entities). For each site where ground-truth PV labels are available, the data processing system 150 can load or obtain relevant data from the first training stage. The relevant data can include kₒₚₜ, and if a regression model with one or more additional features (or variables) was produced, the data processing system 150 can load the coefficients of the one or more additional features. The relevant data can include time series of the components in the total in-plane irradiance (e.g., beam, sky diffuse, and ground reflected) computed in the first training stage, corresponding to the optimal tilt and azimuth pair.

The data processing system 150 can obtain or load the time series from any additional features of interest to be used in the second-stage model, such as weather information or features or properties of the AC current or voltage signals at the site. The data processing system 150 can load the time series of ground-truth PV generation.

The data processing system 150 can define or determine a time series of normalized PV generation. In some cases, if no regression model was produced in at least a portion of the first training stage, the normalized PV generation can be the PV generation divided by kₒₚₜ. Otherwise, if the regression model was produced in the first training stage, the data processing system 150 may perform one or more operations. For example, the data processing system 150 can compute, generate or evaluate a regression model at each timestamp in the normalized PV generation time series, overwriting the total in-plane irradiance independent variable with zero. This may result in a time series of site-specific corrections to the estimated PV generation for effects of horizon shading, temperature dependence, etc. For example, the data processing system 150 can obtain the normalized PV generation by subtracting the time series of corrections from normalized PV generation, and subsequently dividing the result by kₒₚₜ.

For each sample, the data processing system 150 can append a new row to the training dataset that includes the (e.g., three) irradiance components and/or additional features of interest as a plurality of features, and the normalized PV generation as the target. The data processing system 150 can train at least one regression model from the training data assembled from all sites. This model can be linear regression, a random forest model, or a neural network, among others. The parameters of the second-stage model can be communicated to all sites (e.g., to the metering devices 118 or other data processing systems in other sites) where PV disaggregation can be performed/executed locally.

The data processing system 150 can initiate an inference stage, in response to performing at least one of the first or second training stages. The data processing system 150 may execute the operations of the inference stage periodically (e.g., every 5 minutes) or aperiodically (e.g., in response to a signal from the utility grid 100 or an administrator). During the inference stage, the data processing system can load or obtain the tilt, azimuth, and kₒₚₜ determined from the training stage. If a regression model with additional features was produced, the data processing system 150 may load the coefficients of the additional features.

The data processing system 150 can compute the effective in-plane irradiance. For example, the data processing system 150 can compute the (three) components (e.g., beam, sky diffuse, and ground reflected) of total in-plane irradiance using at least one of DNI, DHI, GHI, solar elevation, or solar azimuth at the specified timestamps, for instance, timestamps similar to the timestamps for calculating the total in-plane irradiance in the first training stage. If the data processing system 150 does not execute the second training stage, the effective in-plane irradiance can be the total in-plane irradiance, computed by summing the three components. Otherwise, if there is the second-stage model, the effective in-plane irradiance can be the output of the global second-stage model, providing the three components and any additional features (e.g., weather features or properties of the AC voltage or current signals) as input features.

The data processing system 150 can determine or estimate disaggregated PV time series. If kₒₚₜ was fitted from regression or selection of a percentile (e.g., in the step to regress kₒₚₜ from a linear fit between total in-plane irradiance and negated base-adjusted net load in the first training stage), the data processing system 150 can multiply the effective in-plane irradiance timeseries by kₒₚₜ. Accordingly, the data processing system can output this time series as the disaggregated PV time series. If the regression model with additional features was produced, the data processing system 150 can evaluate the model, using the effective in-plane irradiance (in instead of the total in-plane irradiance independent variable). Accordingly, the data processing system 150 can return the time series of the estimates as disaggregated PV time series.

The data processing system 150 may upload or send the PV power generation information (e.g., the disaggregated PV time series) to the cloud. The PV power generation information can be used for utility grid management. For example, based on the determined power generation from the PV, the utility grid 100 can adjust the voltage tap settings (e.g., reduce the voltage when power generation is reduced or increase the voltage when the power generation is increased) or adjust the capacitor settings (e.g., adjust the fraction of capacitors that are connected to the load), among other configurations. In some cases, based on the PV power generation, the utility grid 100 can determine one or more transformers to replace, in order to support a relatively higher current, if the power generated by the PV is provided upstream to the grid. The data processing system 150 may take other actions based on the determined power generation by the PV or forecasted power generation, such as dispatching a desired amount of resources to support EV charging accounting for the power generated by the PV and/or stored in the ESS at the site. The data processing system 150 can perform other operations not limited to those discussed herein to estimate the generated power from the PV and take actions based on the PV power generation information. For example, the technical solutions can include a system, comprising one or more processors coupled to memory, the data processing system configured to determine photovoltaic (PV) parameters associated with an entity based on at least historical net load data, historical irradiance data, and historical solar angle data associated with the entity, and determine, using the model, disaggregated PV time series of the entity based on at least the PV parameters.

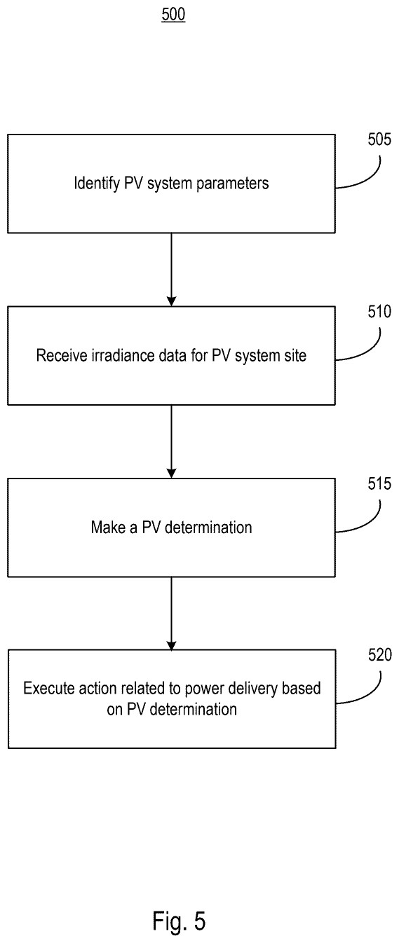

FIG. 5. illustrates a flow diagram of an example method 500 for providing photovoltaic disaggregation from metered net-load. The method 500 can be implemented using any features or components discussed in connection with FIGS. 1-4, including for example data processing system 150 of FIG. 2 implemented on a computing system 300 of FIG. 3 within a utility grid system 100 of FIG. 1. Method 500 can include acts 505-520 that can be implemented using one or more processors 310 coupled with memory 315 on a computing system 300. The memory 315 can include computer code instructions and data to configure or cause the one or more processors 310 to implement various acts or operations 505-520 of the method. At 505, the method can include identifying PV system parameters. At 510, the method can include receiving irradiance data for a PV system site. At 515, the method can include making a PV determination. At 520, the method can include executing an action related to power delivery based on the PV determination.

At 505, the method can include identifying PV system parameters. The method can include one or more processors coupled with memory identifying one or more system parameters, such a tilt, azimuth, and capacity factor for a PV system at a site. The PV system can include one or more solar panels coupled with the grid and configured to generate electricity from solar radiation. The system parameters can include, for example, panel efficiency, temperature coefficient, shading factor, inverter efficiency, panel degradation rate, albedo, orientation, mounting type, array configuration, system losses, or environmental characteristics (e.g., humidity or other weather conditions). The one or more processors can identify the one or more parameters using one or more AI models that can be trained for the specific site, which can be a site that is electrically coupled with an electricity distribution grid. The electricity distribution grid can include a grid system that provides the electricity to or from the site.

The one or more processors are located on a data processing system that can be configured to manage PV disaggregation from a metered net-load on a grid. The data processing system can be deployed on one or more physical or virtual machines, cloud-based system or any other computing environment or a system which can be remote from the site or located on a device at the site that includes the PV system.

The one or more processors can utilize one or more AI models to acquire or identify the system parameters. The system parameters of the PV system can be determined or generated by the one or more AI models from one or more measurements or data corresponding to the PV system, such as PV system technical characteristics or specifications, including specifications of PV or solar panels, electrical or electronic PV controllers, system design or arrangement or any other PV system data. The AI models can determine the system parameters based on the information about the site at which the PV system is located, such as geolocation or coordinates of the system site, elevation of the site, environmental conditions at the site (e.g., humidity, temperature, pressure or wind) or any other site related information. The one or more processors can train the one or more AI models for the site or its PV system, such as based on geographic coordinates for the site, an elevation of the site, or timeseries data comprising historical base-adjusted net-load data for the site, historical irradiance data for the site, or solar position data.

The one or more processors can generate historical in-plane irradiance time series data for the site based on the historical irradiance data and the solar position data. The one or more processors can generate minimum capacity factor time series data based on the historical base-adjusted net-load data and the historical in-plane irradiance time series data. The one or more processors can determine the capacity factor for the photovoltaic system at the site based on a percentile range of the minimum capacity factor time series data. The one or more processors can select the tilt and the azimuth for the capacity factor that corresponds to a minimum value of the minimum capacity factor time series data within the percentile range.

At 510, the method can include receiving irradiance data for a PV system site. The one or more processors can identify, acquire or receive irradiance data for a first time interval. The one or more processors can receive irradiance data for one or more time intervals. The irradiance data can be received from a data repository, which can be located within a data processing system or can be remote from and communicatively coupled with the data processing system (e.g., at a remote database, such as a weather station). The one or more processors can determine an in-plane irradiance based on the irradiance data, the tilt and the azimuth. For example, the one or more processors can calculate the total in-plane irradiance by combining or summing the beam component, sky diffuse component, and ground reflected component, which can be derived from the direct normal irradiance (DNI), diffuse horizontal irradiance (DHI), global horizontal irradiance (GHI), and the solar angles. The processors can then use this in-plane irradiance to estimate the power output of the PV system by applying the capacity factor and other relevant system parameters, such as panel efficiency and temperature coefficient, to generate accurate PV determinations for a particular time interval.

The one or more processors can identify geographic coordinates for the site. The geographic coordinates can include the latitude and longitude of the site, as well as additional location-specific information such as elevation, address, and postal code. This geographic data can facilitate accurately determining the solar irradiance and optimizing the performance of the photovoltaic system at the site.

The one or more processors can transmit, using an application programming interface, via a network, a request for the irradiance data. The request can include the geographic coordinates for the site and an indication of the first time interval. The one or more processors can receive the irradiance data responsive to the request. The irradiance data can include a direct normal irradiance, a diffuse horizontal irradiance, and a global horizontal irradiance. For example, a data processing system can use the direct normal irradiance to calculate the beam component of the in-plane irradiance, the diffuse horizontal irradiance to estimate the sky diffuse component, and the global horizontal irradiance to validate the overall irradiance calculations. These components can then be combined to determine the total in-plane irradiance, which the data processing system can use to compute the power output of the PV system, accounting for various environmental and other factors affecting the solar energy generation at the specific PV system.

At 515, the method can include making a PV determination. The method can include the one or more processors determining any determination corresponding to the PV system. The method can include the one or more processors determining an amount of power generated by the PV system during the first time interval. The PV determination (e.g., the amount of power generated by the PV system during the first time interval), can be determined based on the irradiance data, the tilt, the azimuth, and the capacity factor, or based on any other PV system parameters. For example, the one or more processors can determine the efficiency of the PV system over time or identify potential faults or inefficiencies in the PV system. For example, the one or more processors can estimate the impact of shading and temperature variations on the power generation, which can be used to generate or provide an analysis of the PV system's performance.

The one or more processors can determine an in-plane irradiance based on the irradiance data, the tilt and the azimuth. The one or more processors can determine the amount of power generated by the photovoltaic system based on the in-plane irradiance and the capacity factor. The one or more processors can identify historical net-load time series data for the site. The one or more processors can determine a base load for the site. The base load can correspond to a minimum load present at each time stamp in the historical net-load time series data. The one or more processors can generate the historical base-adjusted net-load data based on a difference between a net-load for the site and the base load time series data for the site. For example, the one or more processors can use this base-adjusted net-load data to identify periods of high solar generation and correlate such periods with weather patterns. The one or more processors can analyze the base-adjusted net-load data to detect anomalies or inefficiencies in the PV system's performance over time.

The one or more processors can compare the amount of power generated by the photovoltaic system during the first time interval with a threshold. The one or more processors can determine, based on the comparison, to adjust a voltage tap setting on the electricity distribution grid. The one or more processors can compare the amount of power generated by the photovoltaic system during the first time interval with a threshold. The one or more processors can determine, based on the comparison, to activate one or more capacitors on the electricity distribution grid.

The one or more processors can determine, based on the amount of power generated by the photovoltaic system during the first time interval, to adjust power delivery by an electric vehicle charger at the site. The one or more processors can determine, based on the amount of power generated by the photovoltaic system during the first time interval, to adjust power delivery by a battery energy storage system at the site.

At 520, the method can include executing an action related to power delivery based on the PV determination. The method can include the one or more processors executing or implementing an action related to power delivery to the site, based on the PV determination made at 515. For instance, the method can include executing an action related to power delivery to the site of the PV system based on the amount of power generated by the PV system during the first time interval (e.g., as determined at 515). For example, the method can include adjusting the charging rates of electric vehicle chargers at the site to adjust (e.g., optimize) energy usage based on the available PV output. For example, the method can include activating or deactivating battery energy storage systems to store excess PV power or provide additional power during low generation periods, thereby maintaining a sufficient or predetermined power level to the site.

The method can include the one or more processors comparing the amount of power generated by the photovoltaic system during the first time interval with a threshold. The one or more processors can determine, based on the comparison, to adjust a voltage tap setting on the electricity distribution grid. The one or more processors can execute the action to adjust the voltage tap setting, responsive to the determination.

The one or more processors can compare the amount of power generated by the photovoltaic system during the first time interval with a threshold. The one or more processors can determine, based on the comparison, to activate one or more capacitors on the electricity distribution grid. The one or more processors can execute the action to activate the one or more capacitors on the electricity distribution grid.

The one or more processors can determine, based on the amount of power generated by the photovoltaic system during the first time interval, to adjust power delivery by an electric vehicle charger at the site. The one or more processors can execute the action to adjust the power delivery by the electric vehicle charger at the site responsive to the determination. The one or more processors can determine, based on the amount of power generated by the photovoltaic system during the first time interval, to adjust power delivery by a battery energy storage system at the site. The one or more processors can execute the action to adjust the power delivery by the battery energy storage system at the site responsive to the determination.

Some of the descriptions herein emphasize the structural independence of the aspects of the system components (e.g., arbitration component) and illustrate one grouping of operations and responsibilities of these system components. Other groupings that execute similar overall operations are understood to be within the scope of the present application. Modules can be implemented in hardware or as computer instructions on a non-transient computer-readable storage medium, and modules can be distributed across various hardware- or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

While this specification contains many specific implementation details, these should not be construed as limitations on the scope of any inventions or of what can be claimed, but rather as descriptions of features specific to particular embodiments of particular aspects. Certain features described in this specification in the context of separate embodiments can also be implemented in combination in a single embodiment. Conversely, various features described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated in a single software product or packaged into multiple software products.

Thus, particular embodiments of the subject matter have been described. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A system, comprising:
one or more processors, coupled with memory, to:
identify, using a model trained for a site electrically coupled with an electricity distribution grid, a tilt, azimuth, and capacity factor for a photovoltaic system at the site;
receive, from a data repository, irradiance data for a first time interval;
determine an amount of power generated by the photovoltaic system during the first time interval based on the irradiance data, the tilt, the azimuth, and the capacity factor; and
execute an action related to power delivery to the site based on the amount of power generated by the photovoltaic system during the first time interval.

2. The system of claim 1, wherein the one or more processors are further configured to:
determine an in-plane irradiance based on the irradiance data, the tilt and the azimuth; and
determine the amount of power generated by the photovoltaic system based on the in-plane irradiance and the capacity factor.

3. The system of claim 1, wherein the one or more processors are further configured to:
identify geographic coordinates for the site;
transmit, using an application programming interface, via a network, a request for the irradiance data, the request including the geographic coordinates for the site and an indication of the first time interval; and
receive the irradiance data responsive to the request.

4. The system of claim 1, wherein the irradiance data comprises a direct normal irradiance, a diffuse horizontal irradiance, and a global horizontal irradiance.

5. The system of claim 1, wherein the one or more processors are further configured to:
train the model for the site based on geographic coordinates for the site, an elevation of the site, and timeseries data comprising historical base-adjusted net-load data for the site, historical irradiance data for the site, and solar position data.

6. The system of claim 5, wherein the one or more processors are further configured to:
identify historical net-load time series data for the site;
determine a base load for the site, wherein the base load corresponds to a minimum load present at each time stamp in the historical net-load time series data; and
generate the historical base-adjusted net-load data based on a difference between a net-load for the site and the base load time series data for the site.

7. The system of claim 5, wherein the one or more processors are further configured to:
generate historical in-plane irradiance time series data for the site based on the historical irradiance data and the solar position data;
generate minimum capacity factor time series data based on the historical base-adjusted net-load data and the historical in-plane irradiance time series data; and
determine the capacity factor for the photovoltaic system at the site based on a percentile range of the minimum capacity factor time series data.

8. The system of claim 7, wherein the one or more processors are further configured to:
select the tilt and the azimuth for the capacity factor that corresponds to a minimum value of the minimum capacity factor time series data within the percentile range.

9. The system of claim 1, wherein the one or more processors are further configured to:
compare the amount of power generated by the photovoltaic system during the first time interval with a threshold;
determine, based on the comparison, to adjust a voltage tap setting on the electricity distribution grid; and
execute the action to adjust the voltage tap setting responsive to the determination.

10. The system of claim 1, wherein the one or more processors are further configured to:
compare the amount of power generated by the photovoltaic system during the first time interval with a threshold;
determine, based on the comparison, to activate one or more capacitors on the electricity distribution grid; and
execute the action to activate the one or more capacitors on the electricity distribution grid.

11. The system of claim 1, wherein the one or more processors are further configured to:
determine, based on the amount of power generated by the photovoltaic system during the first time interval, to adjust power delivery by an electric vehicle charger at the site; and
execute the action to adjust the power delivery by the electric vehicle charger at the site responsive to the determination.

12. The system of claim 1, wherein the one or more processors are further configured to:
determine, based on the amount of power generated by the photovoltaic system during the first time interval, to adjust power delivery by a battery energy storage system at the site; and
execute the action to adjust the power delivery by the battery energy storage system at the site responsive to the determination.

13. The system of claim 1, wherein the one or more processors are located on a data processing system remote from the site.

14. The system of claim 1, wherein the one or more processors are located on a device at the site.

15. A method, comprising:
identifying, by one or more processors, coupled with memory, using a model trained for a site electrically coupled with an electricity distribution grid, a tilt, azimuth, and capacity factor for a photovoltaic system at the site;
receiving, by the one or more processors, from a data repository, irradiance data for a first time interval;
determining, by the one or more processors, an amount of power generated by the photovoltaic system during the first time interval based on the irradiance data, the tilt, the azimuth, and the capacity factor; and
executing, by the one or more processors, an action related to power delivery to the site based on the amount of power generated by the photovoltaic system during the first time interval.

16. The method of claim 15, comprising:
determining, by the one or more processors, an in-plane irradiance based on the irradiance data, the tilt and the azimuth; and
determining, by the one or more processors, the amount of power generated by the photovoltaic system based on the in-plane irradiance and the capacity factor.

17. The method of claim 15, comprising:
identifying, by the one or more processors, geographic coordinates for the site;
transmitting, by the one or more processors, using an application programming interface, via a network, a request for the irradiance data, the request including the geographic coordinates for the site and an indication of the first time interval; and
receiving, by the one or more processors, the irradiance data responsive to the request.

18. The method of claim 15, comprising:
training the model for the site based on geographic coordinates for the site, an elevation of the site, and timeseries data comprising historical base-adjusted net-load data for the site, historical irradiance data for the site, and solar position data.

19. The method of claim 15, comprising:
comparing, by the one or more processors, the amount of power generated by the photovoltaic system during the first time interval with a threshold;
determining, by the one or more processors, based on the comparison, to adjust a voltage tap setting on the electricity distribution grid; and
executing, by the one or more processors, the action to adjust the voltage tap setting responsive to the determination.

20. A non-transitory computer-readable medium storing processor-executable instructions that, when executed by one or more processors, cause the one or more processors to:
one or more processors, coupled with memory, to:
identify, using a model trained for a site electrically coupled with an electricity distribution grid, a tilt, azimuth, and capacity factor for a photovoltaic system at the site;
receive, from a data repository, irradiance data for a first time interval;
determine an amount of power generated by the photovoltaic system during the first time interval based on the irradiance data, the tilt, the azimuth, and the capacity factor; and
execute an action related to power delivery to the site based on the amount of power generated by the photovoltaic system during the first time interval.
